(19) United States
(12) Patent Application Publication
(10) Pub. No.: US 2022/0391575 A1
(43) Pub. Date: Dec. 8, 2022

(54) System for Automated Touchless Contract Management

(71) Applicant: Cinergy Technology Ltd (t/a Gatekeeper), St Helier (GB)

(72) Inventor: Patrick O'Connor, St. Helier (GB)

(73) Assignee: Cinergy Technology Ltd (t/a Gatekeeper), St Helier (GB)

(21) Appl. No.: 17/340,029

(22) Filed: Jun. 6, 2021

(51) Int. Cl. G06F 40/114; G06F 40/174; G06F 40/14; G06F 40/157; G06Q 40/02

(52) U.S. Cl. CPC G06F 40/114; G06F 40/174; G06F 40/14; G06F 40/157; G06Q 40/025; G06Q 2220/10

(57) ABSTRACT

A system for auto generating agreements wherein a requester can initiate a contract generation and provide requested data for auto creation of an agreement from a dynamic document template with optional terms and clauses dependent on the provided data. The dynamic document is then formatted to generate a static document for routing and collecting electronic signatures. The executed document can be stored in a central repository and associated with the original provided data, generate metadata, the agreement terms, and other transaction specific information for subsequent retrieval and/or analysis.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

### Field of the Invention

The invention relates generally to data processing systems or methods, specifically adapted for administrative, and managerial systems or methods. More particularly, the invention relates to computerized arrangement, applying systematic or analysis to the operation(s) of an enterprise to understand the operations(s), improve effectiveness, for the purpose of accomplishing a goal.

While the invention focuses on the operation(s) of an enterprise related to the handling of legal documents (contracts), it does not require the work be performed by a lawyer for a client. Only pre-processing, classifications, and guidance requires lawyer involvement.

In this description, the documents described are contracts or agreement, which are documents that inform, but also delineate an agreement between multiple parties. This agreement can be made through the issuance and receipt of information or may require signatures or other indications to show party acceptance. The terms contract or agreement are interchangeably used herein unless the specific language or context dictates otherwise.

The terms contract or agreement are not, in this teaching, limited to a fully enforceable document within the court system, but is more generally used to include moral contracts, descriptions of party intentions, clarifications of understanding, etc. as required in the instance described.

Once skilled in the arts understands that a document is, in the broad sense, just a representation of information. It is common in electronically managed information, such as presented here, that a document may be generally represented by a document object model (“DOM”).

DOMs are traditional object-oriented designs encompassing the structure and behavior of the objects having defined interfaces of interaction therebetween. These interfaces allow independence between various object types and thus allow growth of the DOM as features evolve.

One structure of a DOM which is commonly recognized by those skilled in the arts is a segmented collection of associated document information (“Layers”). Layers may include et al.: data fields, states, metadata, and other characteristics which may be related or referenced to the base document and/or to other layers.

A layer can also describe requirements and/or rules defining how processing, presentation, and other actions occur regarding the layer information. In this teaching, a layer describes document information that is compartmentalized.

In some instances, compartmentalization provides efficiency by allowing a single instance of information to be referenced by multiple documents. I.e., a one-to-many relationship, e.g., a standard contract clause. In other instances, compartmentalization provides branching or versioning capability allowing multiple instances of similar information to be made unique for different documents. E.g., standard products list with incentive discounts for select customers.

Contracts are the preferred embodiment described herein, but one skilled in the art would appreciate that the innovation is applicable to other documents that may are not meet the legal definition of a contract. I.e., mutual promises between negotiating parties exchanged through an offer by one party that is acceptance by the other which specifies pertinent terms of a bargain.

Elements include but are not limited to one or more of the following: identified parties, agents and/or signatories with capacity, essential terms of mutual definition, an offer followed by an acceptance of that offer. The documents may be contracts, job offers, liability waivers, financial documents, invoices, action consents, notices, announcements, etc.

### Background of the Invention

The expanding world marketplace means parties are less likely to gather in a room to execute paper documents memorializing a transaction. The paperless office may eliminate the physical documents, but businesses still require their content. The number of such documents continues to grow as business gets more sophisticated and societies get more litigious.

Currently a business has the option of gathering electronic signatures on a document, then distributing executed copies to all parties for record keeping needs. The copies may simply be filed, or reviewed periodically to ensure compliance, for government reporting requirements, company analysis, trend determination, etc. DocuSign offers a version of such services automatically routing documents for electronic signatures, known as an “E-Signature” process.

The most common document format used in the E-Signature process a static document in Portable Document Format (“PDF”), but other types of documents maybe used as well. The E-Signature process involves associating a document to be signed (the document layer) with addressing data or form data (the form layer). The form layer's data is a collection of fields describing the signees, and other instance specific data which may customize the document layer.

The data from the form layer is positioned on the document layer manually, or through use of a document template which matches the two layers to complete the specific instance of the document for the E-Signature Process. The form layer data also specifies, et al., addressing, routing/signature order, and tracking information, etc., necessary to collect the e-signatures and/or complete the document which is referenced as its envelope in some implementations.

As the envelope containing document progresses through the E-Signature Process, additional information is generated that must be maintained, including but not limited to approvals, signatures, audit/verification info, data-keys, etc. This information is stored in another layer (the E-Sign layer) which is associated with the document layer and the envelope layer to form the fully executed document and/or a full audit trail of the E-Signature Process.

While a document template may be used to match the form layer and the document layer, the data of the form layer must be manually entered. The PDF is a static document with pre-allocated blanks or locations for supplied data, regardless of the actual amount of data to be included. Changes in the document layer can confuse the document template preventing a proper match requiring manual alignment of the layers.

An inflexible document layer means data may not fit the provided locations. This may cause omissions, overruns, illegibility, or other forms of data corruption. The corruptions may alter the intent of the parties, invalidate portions or the entire agreement, and/or may prevent legal enforcement.

Manual data entry into the form layer, and/or manual alignment with the document layer is time consuming, imprecise, and ripe for errors that may invalidate the fully executed document. While an invalid final version of the fully executed document would render the entire E-Signature Process moot, it could be made worse if the invalidity is not detected by the E-Signature Process.

If the c-signature process allows unidentified errors in the final document, the parties may proceed with the mistaken belief their contractual agreement is properly memorialized. In the case of legally enforceable agreements, any invalid agreement could later be subjected, after party positions have shifted, to being rescinded, re-negotiated, mediated, and/or arbitrated. If those fail, litigation could leave interpretation, intentions, and reformation in the hands of an overworked judge, or a collection of unsophisticated jurors.

Finally, even if the e-signature process is completed without error, the result of the DocuSign system described above is a fully executed document (the “final document”) returned to the envelope creator for storage in the DocuSign system. It is the responsibility of the envelope creator to send the final document to all parties requiring completed copies for their records and/or verification.

The final document, by default, becomes a siloed document. There is no monitoring for renewal tracking, there is no meta data for analysis and/or compliance tracking. This is a downstream business risk for all parties involved.

### BRIEF DESCRIPTION OF THE DRAWINGS

FIG. 1 illustrates the currently available end to end process of e-signature implementation.

FIG. 2 illustrates an improved document creation and e-signature process in accordance with an exemplary embodiment of the innovation.

FIG. 3 shows an improved document management system in accordance with an exemplary embodiment of the innovation.

### DETAILED DESCRIPTION OF THE PREFERRED EMBODIMENTS

The innovation described herein is a contract management system for an end user, to self-serve their contract needs from the implementer/a company. The system automates the generation of dynamic documents for use in an electronic signing process resulting in a trackable agreement document, allowing analysis, review, tracking, and/or automation of other activities during the document's maintenance lifecycle.

The innovation involves implementing an industry unique Kanban workflow engine and secure messaging capabilities to manage contracts in a database implementation. The contract management system triggers various workflow activities as the database records defining a transaction progress from one phase to the next within the company.

Complex processes with varying actions, routings, event sequences, etc. dependent on transaction types, values, business unit, or some other characteristic can be accommodated with conditional logic and other workflow implementations to handle many different permutations. Secure messaging capabilities ensure everyone involved can be automatically informed at any phase change during the process.

Providing a counterparty user the ability to initiate the contract process by triggering a form layer, starting a transaction, which is automated to progress through each of the remaining phases, results in an innovative self-service system that provides the contract services without requiring Company involvement. I.e., a touchless self-service automated contract system.

The description below uses a database implementation of structured objects represented with a DOM having multiple layers to reference document elements, activities, etc. in terms familiar to someone skilled in the arts of electronic document management for describing program implementations. The system describes creation of a Master System Record (a “Master Record”) memorializing or generating a transaction in a database implementation of the DOM.

The DOM comprises a Master Record, and various layers which are comprised of referenced (or linked) records in various other databases. Business rules are implemented as part of validation during record commitment to trigger activities which occur immediately or may be scheduled for a later time or event.

The database implementation of the DOM works in conjunction with a workflow engine to designate and schedule AutoActions specifying activities and document contents: specific terms, agreement elements, definitions, standard clauses, and any specific language, additions, and/or modifications to standard clauses used to flesh a document template and manage the contract lifecycle.

The preferred embodiment described here provides self-service contract generation for services such as employee onboarding, employee reporting and compliance requirements, or external users for high-volume issues like NDAs. One skilled in the art will appreciate other embodiments once the teaching presented herein are fully understood.

Contract management software (“CMS”) is becoming more prevalent in offices. It brings order and compliance to a clause and template library by collecting everything together so legal, and other stakeholders can rationalize and control what is being used. This makes contracts easier to create and reduces risk.

A user can generate a contract by selecting from a template library the needed document structure for the type of transaction. Financial elements, geographic regions, product details, can then be used to determine supplemental clauses which may need to be included. The CMS user then uses the transaction specifics to ‘fill-in-the-blanks’ generating a completed draft for review and approval within the company.

Finally, a final document can be sent to the transaction parties for e-Signatures, with the executed document being returned to the CMS's centralized repository for easy reference at a later time. But this process can be further improved by reducing the company's required activity and in some cases eliminating their need to touch the document at all.

The preferred embodiment implements a template and clause library of various document templates for various supported transactions. The templates and clauses are maintained by legal counsel and other company authorities. Instances of the form layer define the templates and information for specific transactions. The form layer may also include business rules controlling information allowed in a specific template. E.g., a vehicle lease agreement may limit ‘designated drivers’ to individuals at least twenty-five years of age.

Some forms include clauses that may be designated for inclusion in a template based on information provided by a user or may be selected as an option by the user. E.g., a user's address may be used to determine the jurisdiction designated for enforcement actions. Some information may be determinable from other supplied information. E.g., an end date may be calculated by the system based on a start date and limited to a specific contractual telco length.

One improvement described here allows a counter-party user to self-serve contracts rather than waiting for the company to initiate the process. The systems' user (a “counterparty user” or “CP-User”) may be external to a company (e.g., a customer submitting a sales order), or internal (e.g., an employee customizing a benefits program.)

A counterparty user begins the contract self-serve process by triggering a workflow within the system through a uniform resource locator (“URL”) selected from a company website, provided by HR in an acceptance letter, etc. The workflow begins by querying the CP-User for information for populating the form layer of a document based on the desired transaction.

In one embodiment, the URL may provide for execution of a non-disclosure agreement (an “NDA”) the required by the company before an outsider visits one of their manufacturing facilities. In another embodiment, employee on-boarding may require acknowledgement of receiving a copy of the company handbook, authorization to deduct the benefit contributions from the employee's regular payroll allocations.

In other embodiments, self-serve contracts may be incorporated into other company aspects, such as being part of a sales program which provides property lease agreements, or delivery/shipping agreements for product orders. One skilled in the art will appreciate that various elements of this innovation may be applicable to a wide variety of transactions generating many advantages to the current practices in the industry.

The form layer for a particular transaction may be as simple as an email address, or an employee ID number. The employee on-boarding example above may only require the user enter their employee ID number. Once the specific employee is identified, all other information should be in the company's records. In more complex embodiments may implement multiple transactions from a single URL or utilize other business logic to better facilitate self-service of CP-Users while managing company risk.

In some transactions further information may be required for the form layer. As an example, consider the NDA example above. If advanced authorization is required, a visitor may already be vetted so the date, time, facility designation, etc. may already be in a database and easily looked up. However, if the NDA process is not coordinated in advance, the CP-User may need to provide significantly more information.

To assist, the preferred embodiment implements self-building data. Self-building data uses artificial intelligence (“AI”) and machine learning (“ML”) to search company records and/or external data feeds to locate and provide missing data which matches the CP-User's supplied data. Self-building data presents resulting matches to the CP-User for updating/editing and reducing the need for raw data entry.

When the form layer is submitted a Counterparty User record is generated for the individual in the Counterparty User database, or if one already existed, the data is updated. AutoActions are then scheduled or immediately executed to supplement the Counterparty User record by searching external databases for the individual user. E.g., Director Searches, Know Your Customer (KYC) checks, EDGAR searches, etc.

Utilizing AI and ML to identify and compare resulting search information, the Counterparty User record may be directed through a Risk Mitigation Workflow. In the preferred embodiment a range of criteria may be established by the Company to define risk types and exposure levels constituting need for mitigation. Risk Mitigation Workflow may include: paper signatures, requiring a co-signer, proof of agency, etc.

When the form layer is submitted, a Counterparty record is generated for the business entity in the Counterparty database, or if one already existed, the data is updated. The individual's Counterparty User record is then linked to the Counterparty record the individual is associated with. AutoActions are then scheduled or immediately executed to supplement the Counterparty record by searching external databases for the business entity. E.g., financial/earnings records, credit scores, EDGAR searches, etc.

Utilizing AI and ML to identify and compare resulting search information, the Counterparty record may be directed through a Risk Mitigation Workflow. In the preferred embodiment a range of criteria may be established by the Company to define risk types and exposure levels constituting need for mitigation. Risk Mitigation Workflow may include: modified terms (e.g., interest adjustment, reduced credit line, higher level sign-off, etc.), manual data verification, and/or other activities depending on the risk type and exposure level.

The form layer submission generates a Contract record in the Contract database. The contract record information is related to the Counterparty record (for business entity information), and to the Counterparty User record (for contract owner information). It also designates the template and any clauses to be included. Additional metadata specified in the form layer, collected from the user, or generated by the system can be included in the Contract record.

As an example, a contract start date may be entered by the CP-User or specified in the form layer as the layer's submission date. An end date may be generated as the start date+36 months indicating a 3-year contract term. Additionally, an AutoAction can be scheduled to trigger a specific time period before the end date initiating a Contract Renewal Workflow.

In the preferred embodiment the template and clause library's records use handlebar syntax to make the templates and clauses dynamic. Committing the Contract record to the Contract database automates the creation of a dynamic contract document, a Microsoft Word document in the preferred embodiment.

The handlebar syntax within the dynamic contract document supports flexibility by allowing unlimited amounts of clause data and other information to be embedded at indicated locations. Additionally, handlebar markers may remain in the generated dynamic contract document to support E-Signature capabilities later in the process.

The preferred embodiment's Microsoft Word version of the dynamic contract document assists negotiation activities through Microsoft Word's embedded ‘track changes’ capabilities. But negotiations should be unnecessary for a self-serve touchless contract, so the system may progress directly to generation of a final static document such as a PDF followed by presentation to the CP-User for preview on a PDF viewer.

The Word-to-PDF conversion may generate an ISO 19005-1 compliant (PDF/A) file with embedded text/fonts, or an Optical Character Recognition (OCR) engine can be used to support full-text search. The final static document is then paired with an e-Sign layer for the E-Signature process by routing to the Counterparty user, and the nominated internal user.

The nominated internal user may be designated in the forms layer, included as part of the template, or determined through application of business rules which nominate an internal user based on content, risk, or other criteria in the Contract record.

When complete, the executed document is stored in a central contract repository. It is also located in the Contract Database, which is linked to the Counterparty and Counterparty User, with a full E-Sign audit trail including IP addresses and timestamps. This means that in addition to tracking the actual contract document, the data and metadata is also linked for searching, reporting, and other continued management activities.

### DETAILED DESCRIPTION OF THE DRAWINGS

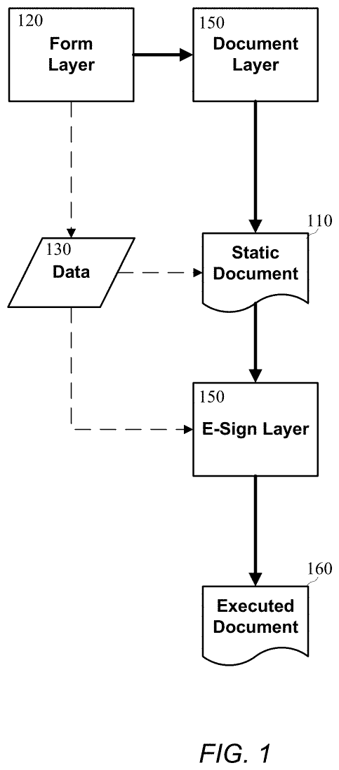

FIG. 1 illustrates the currently available end to end process of e-signature implementation. A form is provided (120) that is linked to a document (110) The form contains fields that are manually completed to supply data (130). The data (130) is associated (150) with corresponding locations on the document (110).

The document (110) is then sent to a user for creating an e-sign layer (150) by manually providing additional data (130), which may duplicate data (130) previously entered through the form (120).

The executed document (160) is then stored in the e-sign system along with an audit trail of the signatures. The document is not searchable or associated with separate data, nor is it sent automatically to signing parties.

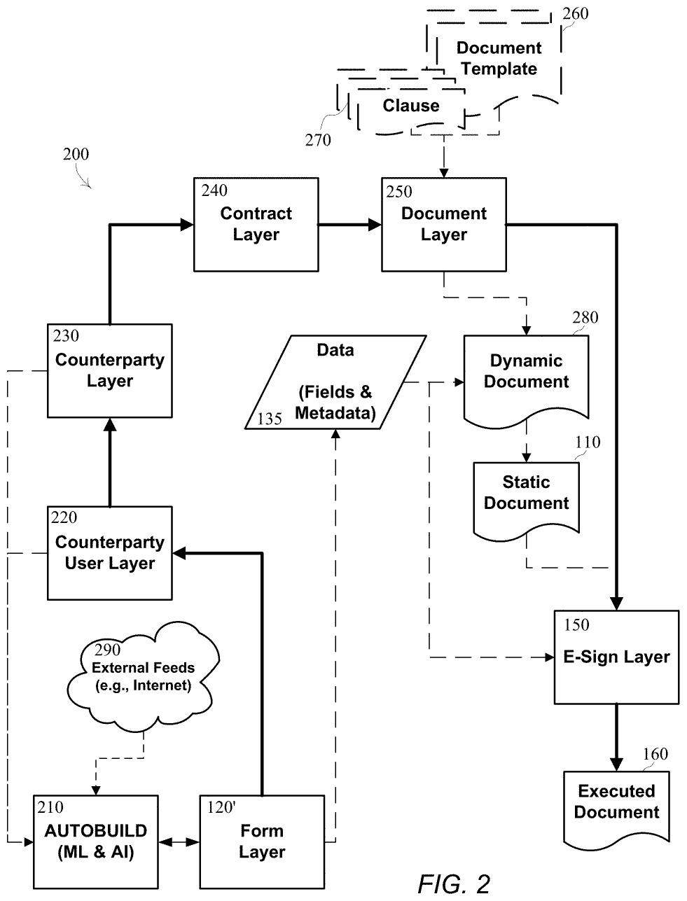

FIG. 2 illustrates an improved document creation and e-signature process in accordance with an exemplary embodiment of the innovation. In the embodiment illustrated (200), a form layer (120′) is activated from a URL, email, or other “external” source allowing for the ‘counterparty user’ to instigate a document/contractual agreement with a company, in this instance, the owner/manager of the system.

The Form Layer (120′) collects data from a user (135), with the assistance of Autobuild (210). Autobuild (210) utilizes Machine Learning (ML) and/or Artificial Intelligence (AL) methods to supplement collected data with additional information. This information may be retrieved from external feeds (290) including company databases, 3rd party data feeds, or search results from the Internet.

For instance, someone wishes to visit a company's development facility. The company requires an NDA and/or other contractual arrangements be in place. The visitor supplies an email address. Autobuild (210) uses the domain to determine the visitor's company, and pre-fills any other information it can.

This means a visitor from a regular customer will likely have all information prefilled, saving them the data entry. Or a group of visitors from the same company may only need to enter company name and address once for the first person, and all others are pre-filled.

Once data (1.35) is collected (120′), the system (200) generates or updates company records. In the illustrated embodiment, collected data includes but is not limited to, the individual visitor, in the counterparty user layer (220), the visitor's company, in the counterparty layer (230), and the agreement specifics, in the contract layer (240).

The agreement specifics, in the contract layer (240) are then used to create the document layer (250) to associate a document template (260), and optionally one or more clauses (270) with fields & metadata, the data (135) to generate a dynamic document (280). The dynamic document is then formatted into a static document (110).

The static document (110) is then associated with an addressing package using data already known (135) and routed through the e-signature process to populate the e-sign layer (150). The executed document (160) is then stored in the system along with an audit trail of the signatures and associated with the contract layer (240).

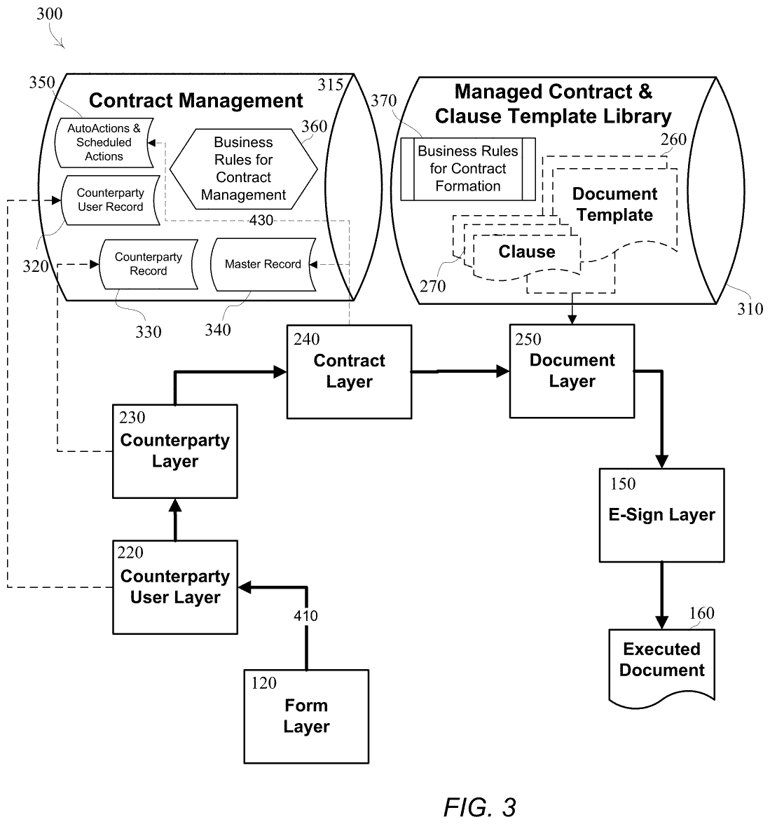

FIG. 3 shows an improved document management system in accordance with an exemplary embodiment of the innovation. The document management system (300) creates records in a contract management database (315), which may or may not be the same database used for the managed contract & clauses template library (310). Submission (410) of the form layer (120) causes the counterparty user layer (220) to update or create a new counterparty user record (320) and causes the counterparty layer (230) to update or create a new counterparty record (330).

Submission (410) also generates the contract layer (240) which applies business rules for contract formation (370) to determine a document template (260) and clauses (270) for the document layer (250). The contract layer (240) also uses business rules for contract management (360) to generate internal logic triggered activity, referred to as AutoActions & scheduled actions (350) for continued management of the contract represented by the master record (340).

The flow diagrams in accordance with exemplary embodiments of the present innovation are provided as examples and should not be construed to limit other embodiments within the scope of the innovation. For instance, the blocks should not be construed as steps that must proceed in a particular order. Additional blocks/steps may be added, some blocks/steps removed, or the order of the blocks/steps altered and still be within the scope of the innovation.

Further, blocks within different figures can be added to or exchanged with other blocks in other figures. Further yet, specific numerical data values (such as specific quantities, numbers, categories, etc.) or other specific information should be interpreted as illustrative for discussing exemplary embodiments. Such specific information is not provided to limit the innovation.

In the various embodiments in accordance with the present innovation, embodiments are implemented as a method, system, and/or apparatus. As one example, exemplary embodiments are implemented as one or more computer software programs to implement the methods described herein. The software is implemented as one or more modules (also referred to as code subroutines, or “objects” in object-oriented programming). The location of the software will differ for the various alternative embodiments.

The software programming code, for example, is accessed by a processor or processors of the computer or server from long-term storage media of some type, such as a CD-ROM drive or hard drive. The software programming code is embodied or stored on any of a variety of known media for use with a data processing system or in any memory device such as semiconductor, magnetic and optical devices, including a disk, hard drive, CD-ROM, ROM, etc.

The code is distributed on such media or is distributed to users from the memory or storage of one computer system over a network of some type to other computer systems for use by users of such other systems. Alternatively, the programming code is embodied in the memory (such as memory of the handheld portable electronic device) and accessed by the processor using the bus. The techniques and methods for embodying software programming code in memory, on physical media, and/or distributing software code via networks are well known and will not be further discussed herein.

The above discussion is meant to be illustrative of the principles and various embodiments of the present innovation. Numerous variations and modifications will become apparent to those skilled in the art once the above disclosure is fully appreciated. It is intended that the following claims be interpreted to embrace all such variations and modifications.

What is claimed is:

1. An auto contract generation system comprising:
in response to a request from a requestor, auto generating an agreement, wherein
auto generating an agreement comprises:
collecting data from the requestor;
supplementing the collected data and confirming, supplied data;
selecting a document template from a library of templates;
merging the document template with supplied data into a dynamic document, a document layer;
formatting the dynamic document into a static document; and
generating an addressing package for the static document;
collect signatures & audit information, e-sign layer;
associating the c-sign layer, static document, document layer, and the supplied data in a centralized repository for subsequent reference.

2. The system in claim 1, wherein the request from a requestor comprises:
clicking a link on a webpage;
submitting a request from a website;
sending an e-mail; or
activating a URL.

3. The system in claim 1, wherein collecting data from the requestor comprises:
presenting and/or receiving input from forms;
requesting and/or accepting formatted data;
surveying a user.

4. The system in claim 1, wherein collecting data from the requestor further comprises:
creating records in the system for analysis, tracking, and/or management of agreement.

5. The system in claim 3, wherein collecting data from the requestor further comprises:
analyzing collected data, pre-filling responses, and allowing requestor to confirm or edit the pre-filled responses.

6. The system in claim 5, wherein analyzing collected data comprises applying machine learning and/or artificial intelligence to partially match records from data feeds comprising:
previous system transactions;
company databases;
commercial information services;
publicly accessible data records; and/or
Internet search results.

7. The system in claim 6, further comprising creating or updating system data and/or company databases with confirmed or edited pre-filled responses.

8. The system in claim 7, further comprising scheduling future management actions associated with the agreement, requestor, counterparty, or other related matters.

9. The system in claim 1, wherein the library of templates further comprises clauses for inclusion in document template.

10. The system in claim 1, wherein the library of templates further comprises business rules for contract formation.

11. The system in claim 10 wherein collecting data from the requestor further comprises:
analyzing collected data, to selectively determine agreement terms and/or options presented to the requestor.

12. The system in claim 10 wherein merging the document template with supplied data into a dynamic document further comprises applying business rules to supplied data for selection of a document template.

13. The system in claim 10 wherein merging the document template with supplied data into a dynamic document further comprises analyzing supplied data to selectively include one or more clauses in the document template.

14. The system in claim 4, wherein analysis, tracking, and/or management of agreement further comprises locating and storing a credit score for the agreement requestor's party.

15. The system in claim 4, wherein analysis, tracking, and/or management of agreement further comprises locating and alerting to compliance issues with government and/or regulatory agencies related to the agreement requestor's party.

16. The system in claim 4, wherein analysis, tracking, and/or management of agreement further comprises scheduling renewal procedures for the agreement.
